(19) United States
(12) Patent Application Publication
(10) Pub. No.: US 2018/0267519 A1
(43) Pub. Date: Sep. 20, 2018

(54) METHOD OF MANUFACTURING PARTS BASED ON THE ANALYSIS OF CENTRING COEFFICIENTS

(71) Applicant: Safran Aircraft Engines, PARIS (FR)

(72) Inventors: Olivier FERRY, Moissy-Cramayel (FR); Arnaud CAMBEFORT, MOISSY-CRAMAYEL (FR); Pascal COURTIN, MOISSY-CRAMAYEL (FR); Nicolas HARDOUIN, MOISSY-CRAMAYEL (FR); Charles CLERET DE LANGAVANT, MOISSY-CRAMAYEL (FR)

(21) Appl. No.: 15/532,476

(22) PCT Filed: Dec. 4, 2015
(86) PCT No.: PCT/FR2015/053333

§ 371 Date: Jun. 1, 2017

(30) Foreign Application Priority Data
Dec. 5, 2014 (FR) 1461994

(51) Int. Cl. G05B 19/418; G06Q 10/06; G06Q 50/04

(52) U.S. Cl. CPC G05B 19/41875; G06Q 10/06395; G05B 2219/32201; G05B 2219/32191; G06Q 50/04

(57) ABSTRACT

The invention pertains to a method of manufacturing parts produced with a manufacturing device, based on the analysis of at least one statistical indicator representative of a characteristic dimension of the parts, according to which: a) in the course of time several samples are collected, each sample comprising several parts produced with the manufacturing device; b) the characteristic dimension of each part of the sample is measured; c) for each sample collected a mean μ and a standard deviation σ of the characteristic dimension measured are calculated, and then a value of a statistical indicator I3C defined according to formula (I) is calculated for each sample collected, where: o Ccₘₐₓ is a maximum centring coefficient imposed for the manufacture of the parts; o TS is an upper tolerance of the characteristic dimension measured; o TI is a lower tolerance of the characteristic dimension measured; d) the value of the statistical indicator I3C thus calculated for the sample collected is compared with a reference value to detect a possible deviation; e) the manufacturing flow for the parts is steered as a function of the results of the comparison by fitting the adjustment parameters of the manufacturing device so as to optimize the deviation between the value of the statistical indicator and the reference value.

$$I 3 C = \frac{Min ( {Cc}_{max} * TS - μ ; μ - {Cc}_{max} * TI )}{3 σ} \qquad ( I )$$

### FIELD OF THE INVENTION

The invention relates to the use of statistical indicators on an industrial scale, for example, in the aeronautics industry, in particular for facilitating the monitoring and control of the manufacturing of parts.

### PRIOR ART

The manufacture of parts, especially mechanical parts, in an industrial setting is met with two opposing constraints: specifically, the increase in manufacturing throughput and volumes on the one hand, and the increased quality requisites on the other, which is particularly true in the aeronautical field.

Today it is difficult to imagine performing quality control on all parts manufactured except to considerably impair manufacturing throughput. Statistical manufacturing indicators are therefore generally used, reliably deducing overall information on the quality of the set of parts manufactured from specific information on the quality of a finite number of parts taken as samples.

Apart from controls at the end of production that can be done on samples having a limited number of parts, checks are generally also made during production to be able to optionally regulate production flow, that is, adjust manufacturing conditions to ensure that the parts made continue to respond to the required quality criteria. In some cases, these statistical controls during production can result in production stopping completely, especially if the parts produced present excessive quality defects and the manufacturing flow must be completely reinitialised.

Quality controls are performed in relation to a characteristic dimension of parts that are manufactured. This characteristic dimension can be for example a particular side of the part, its mass, or any other measurable characteristic of said parts.

To perform statistical controls, several samples are taken successively, each sample comprising several parts of the manufacturing flow, and the characteristic dimension of each part of the sample taken are then measured. The value of a statistical indicator selected previously to monitor the quality of the manufacturing flow is calculated from the different measurements of the characteristic dimension of the parts of the sample taken.

There are various statistical indicators that can be used to monitor the evolution of a manufacturing flow of parts, each statistical indicator giving different information for adjusting the manufacturing conditions in one way or another.

Most statistical indicators used for monitoring an industrial manufacturing process are calculated from an average p and a standard deviation a of the measured characteristic dimension on several parts. More precisely, p corresponds to the average of the decentring measured for the characteristic dimension relative to the reference value for this characteristic dimension.

One of the statistical indicators regularly used is the centring coefficient, noted Cc, which shows restraint imposed on the variations of the average p inside the tolerance interval IT.

The tolerance interval IT is the deviation between the extreme admissible values of the characteristic dimension, therefore being calculated as the difference between the greater tolerance TS and the lesser tolerance TI of the measured characteristic dimension, or IT=TS−TI.

The centring coefficient Cc is generally defined by the formula:

$$Cc = \frac{μ}{( TS - TI ) / 2}$$

In other words, this statistical indicator represents decentring means connected to the interval of tolerances of the side. For example, when the manufacturing plan of the parts specifies a Cc of 0.2, this means that the average is authorised to evolve freely between +/−20% of the tolerance interval. If the tolerance is +/−0.1, this obliges the average to be between +0.02 and −0.02.

In monitoring a manufacturing process with analysis of statistical indicators reference is also made to the intervals of confidence characterising the statistical analysis. The intervals of confidence on average depend not only on the size of the sample and of the average itself, but also on the standard deviation measured.

In fact, given α a degree of confidence (for example α=90%), the interval of confidence of the average μ at the threshold of confidence α of a sample of n parts on which an average μ and a standard deviation σ have been measured is given by:

$${IC}_{α} = [ μ - {t}_{α}^{n - 1} \frac{σ}{\sqrt{n}} ; μ + {t}_{α}^{n - 1} \frac{σ}{\sqrt{n}} ]$$

where t_{α}ⁿ⁻¹ designates the quantile a of the Student law at n−1 degrees of liberty.

Given the definition of the centring coefficient Cc, measurements of centring coefficients that are identical in two samples having the same number of parts, though their standard deviation is different, can be obtained, and will accordingly result in different intervals of confidence on the centring coefficient Cc.

An aim of the present invention is to provide a method for the manufacturing of parts based on the analysis of at least one statistical indicator, which makes it possible to correct the aforementioned problems.

More specifically, an aim of the present invention is to provide a method for the manufacturing of parts based on the analysis of at least one statistical indicator, which gives information on centring of the average of a characteristic dimension studied with reliable and stable manufacturing intervals irrespective of the standard deviation of the characteristic relevant dimension.

### SUMMARY OF THE INVENTION

For this purpose, a method for manufacturing parts is proposed, based on analysis of at least one statistical indicator representative of a characteristic dimension of parts, according to which:
a) several samples are taken over time, each sample comprising several parts made by a manufacturing device;
b) the characteristic dimension of each part of the sample is measured;
c) for each sample taken, an average μ and a standard deviation σ of the characteristic dimension measured are calculated. Then, for each sample, a value of a statistical indicator I3C is taken, defined as per the formula:

$$I 3 C = \frac{Min ( {Cc}_{max} * TS - μ ; μ - {Cc}_{max} * TI )}{3 σ}$$

where:
   Ccₘₐₓ is a maximal centring coefficient imposed for manufacturing parts;
   TS is an upper tolerance of the characteristic dimension measured;
   TI is a lower tolerance of the characteristic dimension measured;
d) the value of the statistical indicator I3C calculated in this way for the sample taken is compared to a reference value, which detects, for example, any standard deviation between the value of the statistical indicator and the reference value;
e) the manufacturing flow of parts is regulated as a function of the results of comparison, preferably by adjusting regulating parameters of the manufacturing device used to make the parts so as to optimise a deviation between the value of the statistical indicator and the reference value.

Each of the steps presented is preferably automated.

The measuring step of the characteristic dimension can be conducted with a measuring device, for example comprising sensors for performing automated measuring of specific dimensions of the part.

The calculation steps can be taken by any appropriate calculation device, such as for example processing computer data means, such as a computer.

The regulating step can be taken for example by a regulating device integrating processing means for integrating and processing data originating from the calculation steps so as to correct any deviation detected in production and correct production flow. In particular, the regulating device is provided to correct the input parameters of the production device from which parts originated.

The regulating device therefore preferably adjusts the regulating parameters of the manufacturing device used to make the parts for example so as to reduce the deviation between the value of the statistical indicator and the reference value

More generally, the aim is to optimise the deviation between the value of the statistical indicator and the reference value so that production of parts complies with requirements of the relevant specification. The production parameters are modified for modifying, or respectively correcting, the deviation identified between the value of the statistical indicator and the reference value. As a function of the statistical indicator used, optimising the deviation could for example consist of reducing the deviation identified.

Preferred, though nonlimiting, aspects of this method, taken singly or in combination, are the following:
at step d) the reference value depends on the number n of parts of the sample taken.
at step d) the reference value is defined by the formula:

$$\frac{{t}_{α}^{n - 1}}{3 \sqrt{n}}$$

where α designates a degree of confidence as a percentage and t_{α}ⁿ⁻¹ designates the quantile α of the Student law at n−1 degrees of liberty.
at step e) if the value of the statistical indicator I3C calculated for the sample taken is greater than or equal to the reference value, the manufacturing conditions of parts are not modified.
at step e), if the value of the statistical indicator I3C calculated for the sample taken is less than the reference value, the manufacturing conditions of parts are not modified and steps a) to e) are reiterated to obtain a value of the statistical indicator I3C calculated for a sample taken that is greater than or equal to the reference value.

### DESCRIPTION OF FIGURES

Other characteristics and advantages of the invention will emerge from the following description, which is purely illustrative and nonlimiting and must be viewed with respect to the attached diagrams, in which:

FIG. 1 is a graphic illustrating the intervals of confidence on the centring coefficients for different standard deviations;

FIG. 2 is a graphic illustrating the imposing on the centring coefficient Cc with the monitoring method according to the invention

FIG. 3 is a diagram illustrating a production chain integrating control and regulation of production with sampling of parts.

### DETAILED DESCRIPTION OF THE INVENTION

In terms of a control plan with monitoring by regular sampling, it is impossible to impose restricting the centring coefficient Cc, which depends only on the size of the sample, as such restricting can be determined a posteriori only, given the standard deviation measured on each sample.

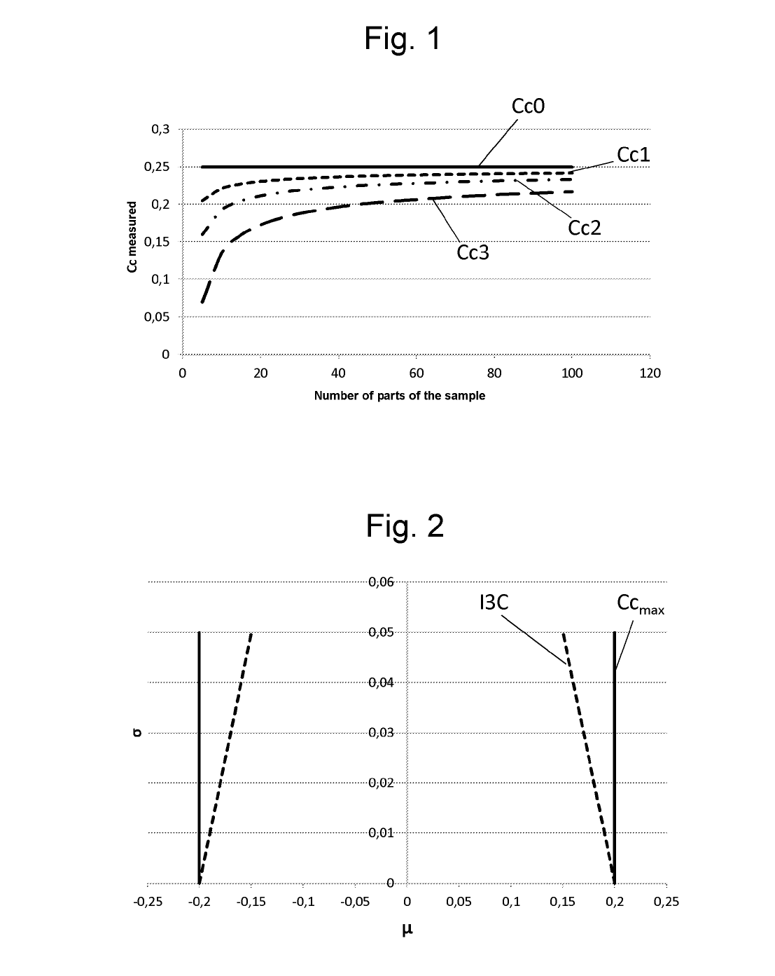

The graphic of FIG. 1 illustrates this impossibility. The curve Cc0 represents the preferred target of Cc, whereas the other curves represent, as a function of the number of parts contained in the sample taken, the maximal centring coefficient to be proven to have an upper terminal of the confidence interval at 5% for the centring coefficient Cc less than the target.

The curve Cc1 corresponds to standard deviation σ equal to 0.05, the curve Cc2 corresponds to a standard deviation σ equal to 0.1, and the curve Cc3 corresponds to a standard deviation σ equal to 0.2.

The graphic of FIG. 1 shows in particular that for a given sample size, the lower the standard deviation of the sample, the less the restriction imposed on the centring coefficient Cc.

A statistical indicator has therefore been developed for monitoring the centring coefficient Cc by taking into account confidence intervals on the average.

More specifically, it is proposed to use a more restricted index than the centring coefficient Cc, which considers the standard deviation measured on each sample.

In an industrial manufacturing flow of parts, over time, several samples are taken, each sample comprising several parts of the manufacturing flow.

For each sample, the characteristic dimension of each part is measured and then for each sample taken, the average μ and the standard deviation σ of the characteristic dimension measured on several parts are calculated.

According to the proposed method for each sample taken a value of a statistical indicator noted I3C will then be calculated, which corresponds to a confidence index on the Centring Coefficient, and which is defined as per the formula:

$$I 3 C = \frac{Min ( {Cc}_{max} * TS - μ ; μ - {Cc}_{max} * TI )}{3 σ}$$

where:
Ccₘₐₓ is the maximal centring coefficient imposed for the manufacturing of parts;
TS is the upper tolerance of the characteristic dimension measured;
TI is the lower tolerance of the characteristic dimension measured.

The next step is to compare the value of the statistical indicator I3C calculated in this way for the sample taken to a reference value, and regulate the manufacturing flow of parts as a function of results of the comparison.

According to an embodiment, if the value of the statistical indicator I3C, calculated for the sample taken, is greater than or equal to the reference value, the manufacturing conditions of parts are not modified. By contrast, if the value of the statistical indicator I3C, calculated for the sample taken, is less than the reference value, the manufacturing conditions of parts are modified so as to modify the manufacturing flow until the samples taken give convenient values of the indicators I3C.

By fixing to the indicator I3C of the sample taken a minimal target to attain depending only on the number of controlled parts, a confidence threshold a ensures that the centring coefficient Cc of the entire population complies with the requirements of the specification.

A reference value is preferably selected given by the formula:

$$\frac{{t}_{α}^{n - 1}}{3 \sqrt{n}}$$

where α designates a degree of confidence as a percentage, and t_{α}ⁿ⁻¹ designates the quantile α of the Student law at n−1 degrees of liberty.

This gives the equivalence:

$$I 3 C > \frac{{t}_{α}^{n - 1}}{3 \sqrt{n}} ⇔ {IC}_{α} ⋐ [ {Cc}_{max} * TI ; {Cc}_{max} * TS ]$$

FIG. 2 is a graphic illustrating the standard deviation as a function of the decentring of the average. Severe imposing on the centring coefficient Cc imposed by the restriction of the indicator I3C in the case of sampling is illustrated on the curve I3C relative to the curve Ccₘₐₓ giving the maximal specification of the centring coefficient imposed in terms of the manufacturing flow.

This confidence index on the centring coefficient I3C therefore overcomes the absence of information on the standard deviation contained in calculating the centring coefficient Cc, which avoids calculating severe generic imposing of the criterion of Cc.

Also, this new indicator I3C can be apprehended similarly to a capability index Cpk defined generally by the formula:

$$Cpk = \frac{Min ( TS - μ ; μ - TI )}{3 σ}$$

The confidence index on the centring coefficient I3C therefore operates similarly to a capability index Cpk, with the essential difference of the terminals at Ccₘₐₓ*TI and Ccₘₐₓ*TS.

Since the capability index Cpk is conventionally used in an industrial setting in monitoring manufacturing processes of parts, the new indicator I3C proposed could therefore easily be implemented without the manufacturing processes being disrupted.

The proposed method can be performed in a manufacturing chain of parts, which can be fully or partially automated, where controls during production regulate the manufacturing flow, that is, adjust the manufacturing conditions to ensure that the finished parts continue to respond to the required quality criteria.

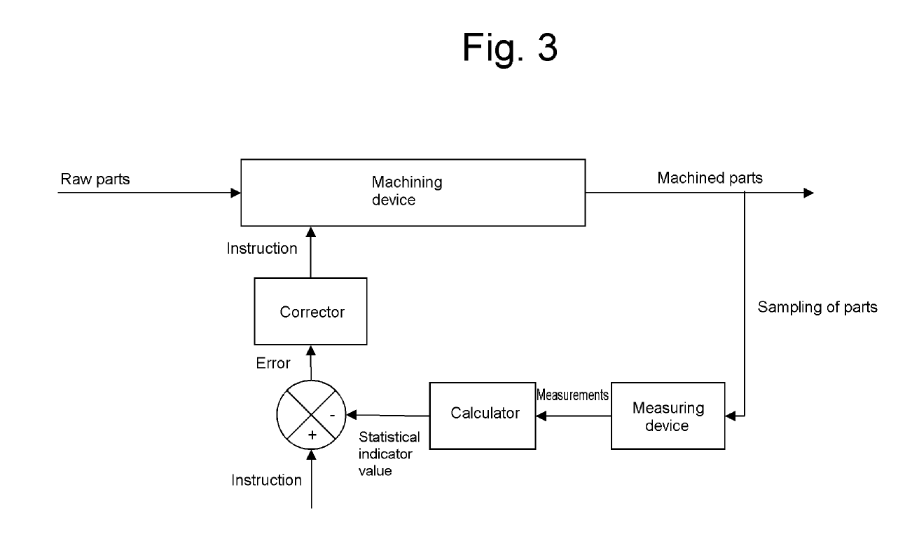

FIG. 3 gives an example of such a manufacturing chain in which a machining device, such as for example a 5-axle machine, is used to make parts according to a specific instruction. The specific instruction can, for example, relate to a particular characteristic dimension. In place of the machining device, a manufacturing device—not limited to the machining of parts—could, of course, be used.

In this automated production chain, parts are sampled when exiting the machining device to form a sample and sent to a measuring device that measures one or more characteristic dimensions of each part of the sample taken. Such a measuring device can for example be a three-dimensional measuring machine having sensors that automatically measure the preferred characteristic dimensions of each of the parts.

The measurement data coming from the measuring device are then sent to a calculation device that processes them to calculate one or more statistical indicators representative of one of the characteristic dimensions of the parts.

The calculated value of the statistical indicator is then compared to a reference instruction on the characteristic dimension so as to manage the manufacturing flow. More precisely, the results of this comparison optionally adjust the input parameters of the machining device.

If a deviation is evident, implying an error, for example, if the value of the statistical indicator on the characteristic dimension is outside an acceptable range defined by the reference instruction, corrective measurements are determined by a corrector to adjust the input parameters of the machining device. The aim of modifications to the input parameters of the machining device, is to correct the evident deviation so that the value of the statistical indicator on the characteristic dimension is back within an acceptable range.

1. A method for manufacturing parts produced with a manufacturing device, based on an analysis of at least one statistical indicator representative of a characteristic dimension of the parts, in which:
a) Over time several samples are taken, each sample comprising several parts produced with the manufacturing device;
b) The characteristic dimension of each part of the sample is measured;
c) An average μ and a standard deviation a of the characteristic dimension measured for each sample taken are calculated, then for each sample taken a value of a statistical indicator I3 C is calculated, as defined according to the formula:
$$I 3 C = \frac{Min ( {Cc}_{max} * TS - μ ; μ - {Cc}_{max} * TI )}{3 σ}$$
where:
Ccₘₐₓ is a maximal centring coefficient imposed for manufacturing parts;
TS is an upper tolerance of the characteristic dimension measured;
TI is a lower tolerance of the characteristic dimension measured;
d) the value of the statistical indicator I3C calculated in this way for the sample taken is compared to a reference value to detect for example any standard deviation between the value of the statistical indicator and the reference value;
e) the manufacturing of parts is regulated as a function of results of comparison by adjusting regulating parameters of the manufacturing device to optimise the deviation between the value of the statistical indicator I3C and the reference value.

2. The method as claimed in claim 1, in which in step d) the reference value depends on the number n of parts of the sample taken.

3. The method as claimed in claim 2, in which in step d) the reference value is defined by the formula:
$$\frac{{t}_{α}^{n - 1}}{3 \sqrt{n}}$$
where:
a designates a degree of confidence in %; and
t_{α}ⁿ⁻¹ designates the quantile a of the Student law at n−1 degrees of liberty.

4. The method as claimed in claim 1, in which in step e), if the value of the statistical indicator I3C calculated for the sample taken is greater than, or equal to the reference value, the manufacturing conditions of the parts are not modified.

5. The method as claimed in claim 1, in which in step e), if the value of the statistical indicator I3C calculated for the sample taken, is less than the reference value, the manufacturing conditions of the parts are not modified and steps a) to e) are reiterated to attain a value of the statistical indicator I3C calculated for a sample taken that is greater than or equal to the reference value.

6. The method as claimed in claim 2, in which in step e), if the value of the statistical indicator I3C calculated for the sample taken is greater than, or equal to the reference value, the manufacturing conditions of the parts are not modified.

7. The method as claimed in claim 3, in which in step e), if the value of the statistical indicator I3C calculated for the sample taken is greater than, or equal to the reference value, the manufacturing conditions of the parts are not modified.

8. The method as claimed in claim 2, in which in step e), if the value of the statistical indicator I3C calculated for the sample taken, is less than the reference value, the manufacturing conditions of the parts are not modified and steps a) to e) are reiterated to attain a value of the statistical indicator I3C calculated for a sample taken that is greater than or equal to the reference value.

9. The method as claimed in claim 3, in which in step e), if the value of the statistical indicator I3C calculated for the sample taken, is less than the reference value, the manufacturing conditions of the parts are not modified and steps a) to e) are reiterated to attain a value of the statistical indicator I3C calculated for a sample taken that is greater than or equal to the reference value.

10. The method as claimed in claim 1, in which in step e),
if the value of the statistical indicator I3C calculated for the sample taken is greater than, or equal to the reference value, the manufacturing conditions of the parts are not modified; and
if the value of the statistical indicator I3C calculated for the sample taken, is less than the reference value, the manufacturing conditions of the parts are not modified and steps a) to e) are reiterated to attain a value of the statistical indicator I3C calculated for a sample taken that is greater than or equal to the reference value.

11. The method as claimed in claim 2, in which in step e),
if the value of the statistical indicator I3C calculated for the sample taken is greater than, or equal to the reference value, the manufacturing conditions of the parts are not modified; and
if the value of the statistical indicator I3C calculated for the sample taken, is less than the reference value, the manufacturing conditions of the parts are not modified and steps a) to e) are reiterated to attain a value of the statistical indicator I3C calculated for a sample taken that is greater than or equal to the reference value.

12. The method as claimed in claim 3, in which in step e),
if the value of the statistical indicator I3C calculated for the sample taken is greater than, or equal to the reference value, the manufacturing conditions of the parts are not modified; and
if the value of the statistical indicator I3C calculated for the sample taken, is less than the reference value, the manufacturing conditions of the parts are not modified and steps a) to e) are reiterated to attain a value of the statistical indicator I3C calculated for a sample taken that is greater than or equal to the reference value.
